(19) United States
(12) Patent Application Publication
(10) Pub. No.: US 2010/0037071 A1
(43) Pub. Date: Feb. 11, 2010

(54) Using Internet to control delivery of power to a set of remote loads(devices)

(76) Inventor: Hsiang-Li Chang, Shanghai (CN)

Correspondence Address: Hsiang-Li Chang, Building 11, Room 601, 500 HuangJinChengDao, Shanghai, 201103, CN

(21) Appl. No.: 12/186,449

(22) Filed: Aug. 5, 2008

(51) Int. Cl. G06F 1/26

(52) U.S. Cl. 713/310

(57) ABSTRACT

This application describes an original concept, model, design, method and components of controlling delivery of power to one or many loads through the internet. It supports global power management as a service model. This service can be optimized with different criteria including but not limited to priority, efficiency, savings, costs, performance, season and time of the day . . . and this service can be implemented by computer software. The design consists of (i) Internet and its distributed data centers/computer clusters/databases/application software/Internet service provider (ii) a new type of web-enabled power cycler (iii) one or more gateway and another new type of wireless PAN/LAN/WAN-enabled power cyclers (iv) devices capable of accessing Internet for remote control.

### CROSS-REFERENCE TO RELATED APPLICATIONS

### U.S. Patent Documents

| | | |
|---|---|---|
| 7,320,078 | January 2008 | Balestriere |
| 7203849 | April 2007 | Dove |
| 2004/0037300 | February 2004 | Lehr et al. |
| 6473608 | October 2002 | Lehr et al. |
| 6643566 | November 2003 | Lehr et al. |
| 6762675 | July 2004 | Cafiero et al. |
| 7032119 | April 2006 | Fung |
| 7050840 | May 2006 | Lin et al. |
| 7058826 | June 2006 | Fung |
| 7155622 | December 2006 | Mancey et al. |
| 2002/0144159 | October 2002 | Wu et al. |
| 2006/0112288 | May 2006 | Schindler |
| 2006/0149978 | July 2006 | Randall et al. |

### OTHER REFERENCE

1. Latest ZIGBEE SPECIFICATION including the PRO Feature Set http:/www.zigbee.org
2. ZIGBEE CLUSTER LIBRARY http:/www.zigbee.org
3. Wireless Personal Area Networks http://standards.ieee.org/getieee802/802.15.html
4. Wireless Local Area Networks/Metropolitan Area Network http://standards.ieee.org/getieee802/802.11.html
5. Advantages of peer-to-peer networks http://www.solyrich.com/p2p-pros-cons.asp
6. TCP/IP Internet Reference Model And Internet Engineering Task Force http://www.ietf.org/
7. Lixin Tao, “Shifting Paradigms with the Application Service Provider Model,” Computer, vol. 34, no. 10, pp. 32-39, October 2001
8. Mobile device platform—gPhone from Google and iPhone from Apple Computer

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

It is known that through the solid state instrument (SSI) component, a power cycler can control voltage sent to one or more loads through its output socket and therefore control the on/off of connected loads. It is also known that through a serial port interface, the power cycler can receive signal from requesters to cycle power without manual intervention. It is known as well that a terminal server typically resides on a computer with adequate resources to run a terminal daemon service and can handle terminal display requests from other computers (referred to as terminal clients) on the same network; This way the requestor (slave) “logging into” the computer running the terminal daemon service (master) from remote; as if the requestor is physically present at the site of the master computer; which is communicating with the power cycler through the serial port interface. Therefore, the requester (slave) issue a power on or off command and the command will be executed on the computer running the terminal daemon service (master) (see reference U.S. Pat. No. 7,320,078 January 2008 Balestriere) This kind of architecture is often referred to as a “master-slave” relationship.

Optimization on energy efficiency and network management is not implemented in this kind architecture.

### BRIEF SUMMARY OF THE INVENTION

It is obvious that there are deficiencies in the above-described scheme. The most evident one is that the requester computer(s) act as a “dumb terminal”. i.e. the requester computer(s) does not consume any computing power, resource, bandwidth or storage space. All the requests are handled by the master computer. All of the logic is programmed on the master computer by software and master computer's serial port sends signal to power cycler to turn on/off load(s). Therefore, the number of requests that can be handled at any given time is dependent upon the availability and health of the master computer. This situation can be described as single point of failure. As opposed to this submitted architecture, all clients may provide resources, including bandwidth, storage space, and computing power. It also has neither feedback nor self-healing capability if the master computer goes down or in maintenance mode. The request simply hangs. It is very limited in terms of system manageability, for example, request authentication (if the requester is allowed to turn on/off the devices?); data security (can other logged users on master computer see such requests?), data protection (can other logged users intercept and alter the request?) data integrity (Is it safe to shut down/turn on the device? Any implication to other loads on site?), data recovery (if the request does not get through the first time, will it be re-sent again? and how?) Also to feedback execution status to the requester, log events (who, when, where, which device . . . ) for history reporting and data analysis/decision making.

Optimization logic (such as minimize power consumption at usage peak time or based on utility company charge rate or adjust lighting luminance or turn off loads when certain user specified criteria are met) can be software programmed and partitioned to reside either in the data centers, gateway, or the new wireless PAN/LAN/WAN-enabled power cycler in this submitted architecture.

### BRIEF DESCRIPTION OF THE SEVERAL VIEWS OF THE DRAWING

The concept, devices, components, parts, features and advantages of the submitted architecture will be apparent from the following description, as illustrated in the accompanying drawings. The drawings are not necessarily to scale, emphasis instead being placed upon illustrating the principles of the concept.

FIG. 1 is a block diagram of a conventional power cycler configured to control power and communications to a set of loads through computer serial port.

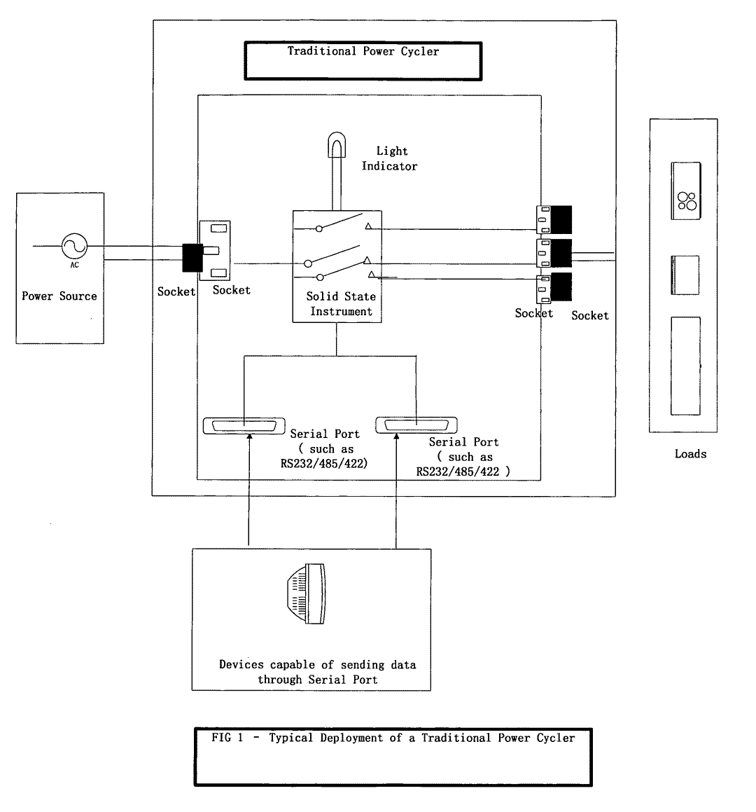

FIG. 2 is a block diagram of the web enabled power cycler. It is a conventional power cycler embedded with a microprocessor capable of receiving/sending data through Internet. Remote control devices can be used to send/receive data to this web enabled power cycler.

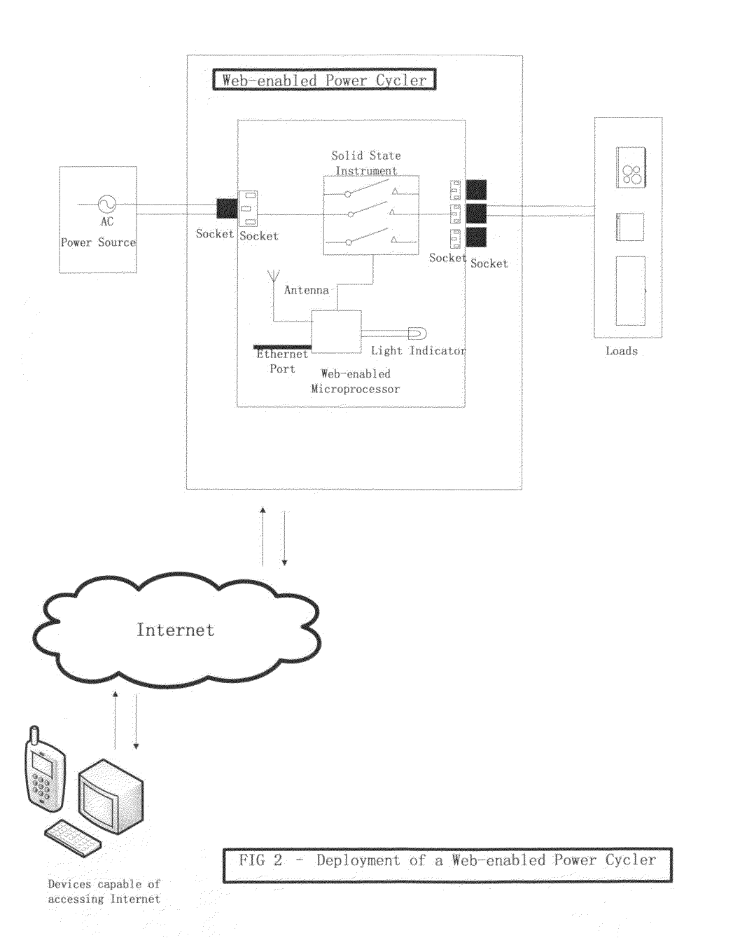

FIG. 3 is a block diagram of a wireless PAN/LAN/WAN-enabled power cycler. It is a power cycler embedded with a microprocessor and a network node. It can perform network functionalities. In addition, the gateway can handle two or more different communication protocols and exchange data between Internet and one or more wireless PAN/LAN/WAN-enabled power cyclers.

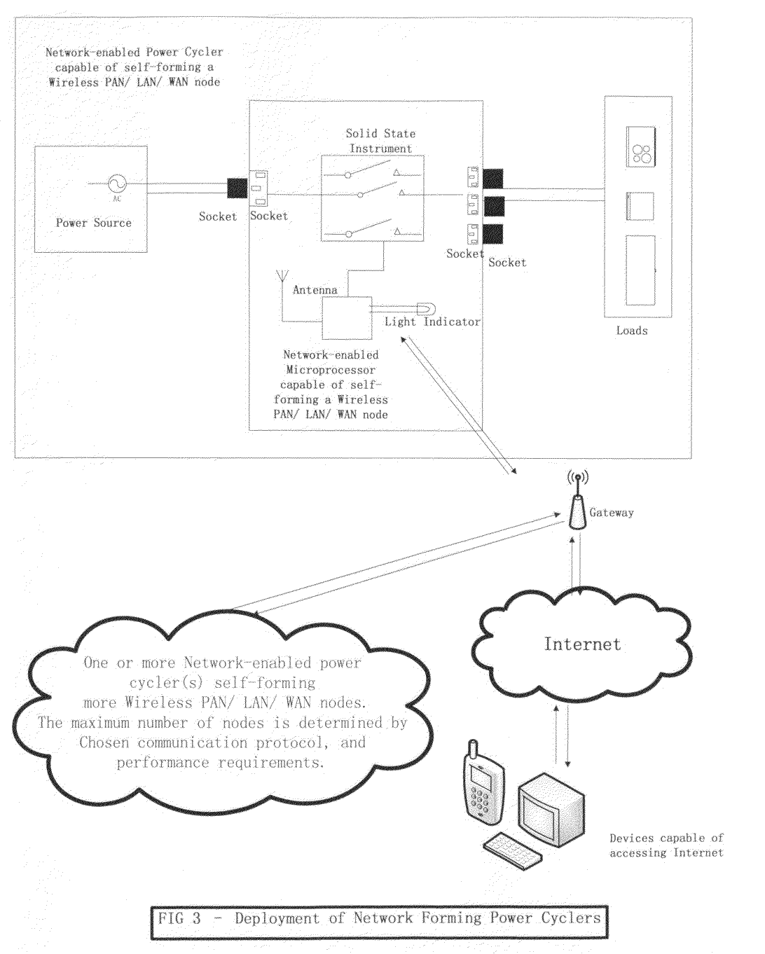

FIG. 4 is a block diagram of an application service provider model that can be used to manage power globally. It is comprised of web enabled power cycler (described in FIG. 2), gateway and wireless PAN/LAN/WAN-enabled power cycler (described in FIG. 3), remote control devices, and Internet (data centers, data clusters, databases and software) and many geographically dispersed loads.

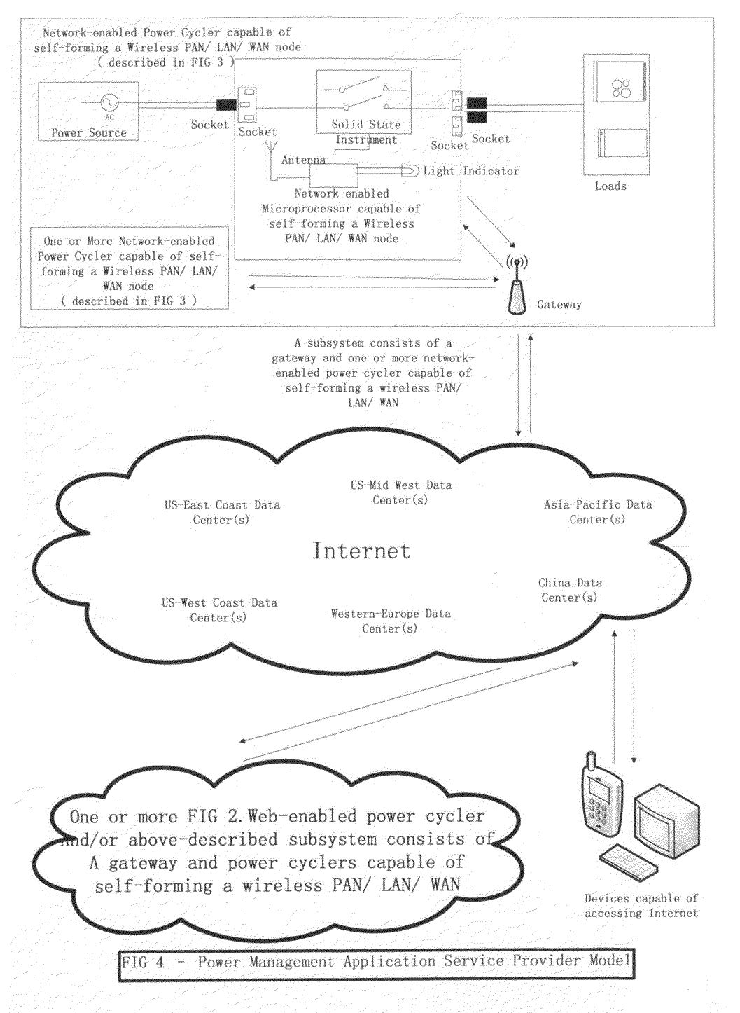

### DETAILED DESCRIPTION OF THE INVENTION

This application describes an original design of controlling delivery of power to one or many loads through the internet using any electronic device that can access Internet as a remote control. In order to accomplish this goal, the design consists of several major parts. The first part is the Internet itself, its communication protocols, bandwidth, resources, distributed data centers, the computer clusters in each data center, and the databases and software logic governing the whole operation residing in these computer clusters. Internet service provider (ISP) also plays an important role with the network uptime and quality of service (QoS) because remote devices access Internet through these providers.

The second part is a sub-system consists of a gateway and one or more wireless PAN/LAN/WAN-enabled power cyclers and many loads connected to each of the power cyclers through power cords and sockets. An AC power source provides power to each of the wireless PAN/LAN/WAN-enabled power cycler. Each wireless PAN/LAN/WAN-enabled power cycler is a power cycler with a microprocessor capable of performing desired communication distance networking functionality and it can communicate with a gateway and the gateway can receive/send data to Internet. Power cyclers receive requests from gateway; execute the requests through the solid state instrument (SSI) component and return the execution status back to the gateway.

The design is configured that (i) gateway can receive requests to turn on/off power to the load(s) from the internet through a wired or wireless communication protocol such as WiFi, Ethernet; (ii) upon receiving such requests, gateway will process and forward the request to the corresponding wireless PAN/LAN/WAN-enabled power cycler; (iii) the corresponding wireless PAN/LAN/WAN-enabled power cycler will handle the request and send feedback information back to gateway upon completion of the request; (iv) gateway will present the feedback/status of request to requestor in a user-preferred customizable fashion; (v) a wireless PAN/LAN/WAN-enabled power cycler can handle one or more loads; (vi) the maximum number of wireless PAN/LAN/ WAN-enabled power cyclers that a gateway can handle is determined by factors such as the hardware, power consumption, transmission distance and the chosen communication protocol.

The gateway is capable of processing two or more different communication protocols, and sending/receiving information to/from Internet. Specifically, the gateway is a hardware embedded with a microprocessor capable of translating one or more PAN/LAN/WAN network protocol(s) such as IEEE802.15, Zigbee, IEEE802.11, WiMax or proprietary . . . etc. to Internet protocols such as TCP/IP and vice versa. In addition to translating between different protocols, the gateway may be programmed by software to perform network administrative tasks and exchange data with the database(s) residing on computer clusters in distributed data center(s) on the Internet. Such tasks include but not limited to check the health of the local devices, diagnose problems, feedback status, record load usage and notify personnel for exception handling and escalation.

Wireless PAN/LAN/WAN-enabled power cyclers may or may not communicate with each other, depending upon system requirement and degree of complexity of the architecture implemented. In the case of the wireless PAN/LAN/WAN-enabled power cyclers communicating with each other, it is referred to as peer-to-peer (P2P) network. In the peer-to-peer network scenario, this system will be fault tolerant i.e. if the gateway goes down, other power cyclers can detect and power cycle the gateway itself. The most sophisticated application logic and advanced features can be implemented through software in the peer-to-peer network scenario such as for loads energy savings, usage recording and reporting, status monitoring and exception handling. The loads energy savings service can be optimized with different criteria including but not limited to priority, efficiency, electricity savings plan, costs, performance, interval of time, season and time of the day . . . etc.

There can be any number of above-mentioned sub-system (a gateway and one or more wireless PAN/LAN/WAN-enabled power cyclers) in the overall deployment depending on the user requirements and application complexity. This makes the whole architecture scalable.

The third part is a new type of web-enabled power cyclers which can be deployed in places where either not a lot of loads need to be controlled or need to build an infrastructure rapidly and easy to install. Each web-enabled power cycler has a embedded microprocessor which can communicate with Internet through wired (such as Ethernet) or wireless (such as WiFi) protocols and therefore can receive/send data to and from Internet; web-enabled power cyclers have an input socket to connect to power source through a power cord, and output sockets to connect to one or many loads through power cord(s). It is most usable when the deployment is less complicated and requires no technical strength such as residential home DIY projects. All the application logic and optimization criteria are implemented and reside on the computer clusters in the data centers.

The fourth part is devices capable of accessing Internet for remote control purpose. Any device that can access (exchange data to and from) Internet can be turned into a remote control for power management for any loads accessible by the gateway. As long as the loads intended to be controlled are attached to wireless PAN/LAN/WAN-enabled power cycler through sockets and Internet QoS meets specification. These remote control for power management devices include but not limited to handheld devices (phones, smart phones, PDA, tablet computers, GPS . . . ), personal computers, laptops, sophisticated servers, . . . etc.

The fifth part is the loads referred throughout this design. They include but not limited to devices, appliances, equipment, machinery, sensors, tools . . . etc. Anything that requires power to be functional and becomes idle when power is switched off is referred to as load. Some loads such as certain light bulbs may support a percentage of full capacity (luminance) can also be deployed. These loads can either be in local or remote geographical locations, since power management commands are passed through Internet. It can span across continents if Internet service provider supports the response time required and data security requirements enforced.

The last part will be the software application logic. This proposed architecture supports global power management as a “service”; therefore an application service provider (ASP) model can be accomplished. If we elaborate on the Internet part; the Internet can contain one or more data centers around the globe. Each data center can have one or many computer clusters. Each computer cluster can have one or more computer with databases and software. Each computer cluster can be programmed to perform certain tasks. Most sophisticated logic can be implemented on these computer clusters in data center(s) based on user requirements; e.g. request authentication (if the requestor is allowed to turn on/off the devices); data security/data protection (disallow other internet users see/hijack/alter such requests), data integrity (Is it safe to shut down/turn on the device? Any impact on the loads nearby?), data recovery (if the request does not get through the first time, will it be re-sent again? and how?) and status feedback to the requester, event logging (who, when, where, which device . . . ), collect data for reporting and provide data analysis for making better decision in the future.

In this multi-tiered architecture, software can be developed and tested in data centers and either reside in data centers or be “pushed” to gateway and/or wireless PAN/LAN/WAN-enabled power cyclers at system upgrade time. The “push method” will save maintenance crew's manual intervention, time and expense to commute back and forth to devices each software upgrade, loads downtime cost and unavoidable human errors.

1. A scalable architecture to remotely control the delivery of power to loads over the Internet.
The architecture is comprised of one or more gateway, one or many wireless PAN/LAN/WAN-enabled power cyclers, one or more web-enabled power cyclers, power cords, sockets, AC power source, one or more loads (devices), Internet broadband service, smart phone or computer or equivalent devices which is capable of accessing Internet for remote control device.
The number of loads remotely manageable is scalable and is dependent upon the number of gateways and wireless PAN/LAN/WAN-enabled power cyclers or web-enabled power cyclers deployed.
Offers freedom to choose a communication protocol either based on open standards or proprietary for the above-designed wireless PAN/LAN/WAN-enabled power cycler and gateway. Any protocol supports communicating with a gateway and self-forming/self-healing a reliable, secured, efficient network will qualify.
Through an Internet software application (either by going to a web site address or built into the remote control device), any device that can access (i.e. exchange data to and from) Internet can be considered to be a remote control for power management for any loads accessible by the gateway. As long as other parts of overall architecture is valid. These remote control for power management devices include but not limited to handheld devices (phones, smart phones, PDA, tablet computers, GPS . . . ), personal desktop computers, laptops, sophisticated servers, . . . etc.
The loads referred throughout the architecture include but not limited to devices, appliances, equipment, machinery, sensors, tools . . . etc. Anything that requires power to be functional and becomes idle when power is switched off is referred to as load. These loads can either be in local or remote geographical locations, since power management commands are passed through Internet. It can span across continents if Internet service provider supports the response time required and data security requirements enforced.

2. The invention of two new types of power cyclers and corresponding gateway.
The first type is a web-enabled power cyclers. Each web-enabled power cycler is a conventional power cycler plus an embedded microprocessor which can communicate with Internet through wired (such as Ethernet) or wireless (such as WiFi) protocols.
Web-enabled power cyclers can be deployed in places where either not a lot of loads need to be controlled or for residential home Do-It-Yourself users to control loads at home remotely while they are out of home. In the residential home owner scenario, loads can be turned on/off either by remote control device signal or based on certain chosen energy savings criteria and the application logic and optimization rules can be implemented and reside on the computer clusters in the distributed data centers and applied to users' loads at home automatically.
The second type is a wireless PAN/LAN/WAN-enabled power cycler, its design, function, specification and self-forming a network characteristic with the proposed gateway based on a chosen network communication protocol.
Each wireless PAN/LAN/WAN-enabled power cycler is a power cycler embedded with a microprocessor capable of performing desired distance network communication tasks. Power cyclers and the gateway can self-form a local network. Power cyclers receive requests from gateway; execute the requests through the semiconductor component and return the execution status back to the gateway.
Wireless PAN/LAN/WAN-enabled power cyclers may or may not communicate with each other, depending upon system requirement and degree of complexity of the architecture implemented. In the case of the wireless PAN/LAN/WAN-enabled power cyclers communicating with each other, it is referred to as peer-to-peer network. In the peer-to-peer network scenario, this system will be fault tolerant i.e. if the gateway goes down, other power cyclers can detect and power cycle the gateway itself. The most sophisticated application logic and advanced features can also be implemented on servers and “pushed” into the peer-to-peer network gateway and wireless power cyclers. The logic includes but not limited to maximize loads energy savings, usage recording and reporting, status monitoring and exception handling. The loads energy savings service can be optimized with different criteria including but not limited to priority, efficiency, electricity savings plan, costs, performance, interval of time, season and time of the day . . . etc.
The “push method” will save maintenance crew's manual intervention, time and expense to commute back and forth to devices, system downtime cost and unavoidable human errors.
The gateway is a hardware embedded with a microprocessor capable of translating one or more PAN/LAN/WAN network protocol (such as IEEE802.11, IEEE802.15, Zigbee, WiMax or proprietary) to Internet protocols such as TCP/IP and vice versa. In addition to translating between different protocols, the gateway may be programmed by software to perform network administrative tasks and exchange data with the database(s) residing on computer clusters in distributed data center(s) on the Internet. Such tasks include but not limited to check the health of the local devices, diagnose problems, feedback status, load usage and notify personnel for exception handling and escalation.

3. This architecture can accomplish power management as an application service provider (ASP) model.
We can elaborate on the Internet part; it consists of one or more data centers around the globe. Each data center can have one or many computer clusters. Each computer cluster can have one or more computer with databases and software. Each computer (cluster) can be programmed to perform certain tasks. The most sophisticated logic can be implemented on these computer clusters in data center(s) based on user requirements; e.g. request authentication (if the requestor is allowed to turn on/off the devices); data security/data protection (disallow other internet users see/hijack/alter such requests), data integrity (will it be safe to shut down/turn on the device? What is the implication to other loads nearby?), data recovery (if the request does not get through the first time, will it be re-sent again? and how?) and status feedback to the requester, event logging (who, when, where, which device . . . ), collect data for reporting and provide data analysis for making better decision in the future.
This design also identified an opportunity to have power cyclers perform more than just turning power on or off, more specifically, maybe control ranges of power (0-100%) for loads applicable. With enhancement or replacement on the power cycler's hardware—solid state instrument, it not only can serve as a switch to turn on/off power, but also can provide ranges of power (0-100%) for certain types of loads to become functional. Such loads include but not limited to control the luminance of street lights, residential and commercial lighting, and other adjustable loads. This flexibility will further realize the benefits of such scalable infrastructure as users save on energy bills without sacrificing quality of life.
